(19) United States
(12) Patent Application Publication
(10) Pub. No.: US 2009/0078077 A1
(43) Pub. Date: Mar. 26, 2009

(54) Centering viscous torsional vibration damper

(76) Inventor: Karl G. Horschel, Springville, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/903,084

(22) Filed: Sep. 20, 2007

(51) Int. Cl. F16F 15/167; F16F 7/10

(52) U.S. Cl. 74/573.1; 188/379

(57) ABSTRACT

A viscous torsional vibration damper comprising a housing adapted to be connected to a rotary member to be damped, the housing comprising an annular chamber having an inner cylindrical surface and an outer cylindrical surface elongated about a central axis, an inertial mass within the chamber and having an inner cylindrical surface and an outer cylindrical surface elongated about an axis of rotation, the inertial mass and the chamber configured such that the inertial mass is rotatable in the chamber relative to the housing, a first annular centering element and a second annular centering element between the opposed inner cylindrical surfaces of the chamber and the inertial mass or the opposed outer cylindrical surfaces of the chamber and the inertial mass, the annular centering elements configured and arranged to bias the axis of rotation of the inertial mass towards alignment with the central axis of the chamber, a clearance gap between the housing and the inertial mass, the clearance gap having a first portion and a second portion separated by at least one of the centering elements, a bypass channel extending through the inertial mass or at least one of the centering elements from the first portion of the clearance gap to the second portion of the clearance gap, and a viscous fluid within the clearance gap.

### TECHNICAL FIELD

The present invention relates generally to viscous torsional vibration dampers, and more particularly to a self-centering viscous torsional vibration damper.

### BACKGROUND ART

Viscous vibration dampers for overcoming torsional oscillations or vibrations in rotary masses such as crankshafts are known in the prior art. For example, U.S. Pat. No. 2,514,139 discloses such a torsional vibration damper. As shown, such dampers generally comprise a damper housing that contains an inertial mass or flywheel. Spaces or gaps between the housing and the inertial mass are filled with a viscous medium. The inertial mass rotates relative to the housing to provide damping by viscous sheer of the viscous medium between the housing and the inertial mass.

### DISCLOSURE OF THE INVENTION

With parenthetical reference to corresponding parts, portions, or surfaces of the disclosed embodiment, merely for purposes of illustration and not by any way of limitation, the present invention provides an improved viscous torsional vibration damper (15) comprising a housing (16) adapted to be connected to a rotary member to be damped, the housing comprising an annular chamber (19) having an inner cylindrical surface (24) and an outer cylindrical surface (21) oriented about a central axis (x-x), an inertial mass (28) within chamber and having an inner cylindrical surface (32) and an outer cylindrical surface (29) oriented about an axis of rotation (r-r), the inertial mass and the chamber configured such that the inertial mass is rotatable in the chamber relative to the housing, a clearance gap (44) between the housing and the inertial mass, a viscous fluid disposed in the clearance gap, at least one centering element (35) between the opposed inner cylindrical surfaces of the chamber and the inertial mass or the opposed outer cylindrical surfaces of the chamber and the inertial mass, and the centering element configured and arranged to bias the axis of rotation of the inertial mass towards alignment with the central axis of said chamber.

The damper may further comprise a second centering element (36) between the opposed inner cylindrical surfaces of the chamber and the inertial mass or the opposed outer cylindrical surfaces of the chamber and the inertial mass, the second centering element configured and arranged with the centering element to bias the axis of rotation of the inertial mass towards alignment with the central axis of the chamber. The centering element may be between the opposed inner cylindrical surfaces of the chamber and the inertial mass and the second centering element may be between the opposed outer cylindrical surfaces of the chamber and the inertial mass. The centering element may be an O-ring. The inner cylindrical surface of the inertial mass may comprise a groove and the O-ring may be seated in the groove and extend in an uncompressed state at least beyond the edge of the groove and the inner cylindrical surface of the inertial mass. The inner cylindrical surface of the inertial mass may comprise a first groove (33) and a second groove (34), the centering element may comprise an O-ring (35) seated in the first groove, and the second centering element may comprise an O-ring (36) seated in the second groove. The outer cylindrical surface of the inertial mass may comprise a first groove and a second groove, the centering element may comprise an O-ring seated in the first groove, and the second centering element may comprise an O-ring seated in the second groove. The inner cylindrical surface of the chamber may comprise a first groove and a second groove, the centering element may comprise an O-ring seated in the first groove, and the second centering element may comprise an O-ring seated in the second groove. The outer cylindrical surface of the chamber may comprise a first groove and a second groove, the centering element may comprise an O-ring seated in the first groove, and the second centering element may comprise an O-ring seated in the second groove. The damper may further comprise a bypass channel (38) extending through the inertial mass. At least one of the chamber and the inertial mass may comprise a recess (25) configured to provide a reservoir for the fluid and the channel may communicate with the reservoir.

In another aspect, the viscous torsional vibration damper may comprise a housing adapted to be connected to a rotary member to be damped, the housing comprising an annular chamber having an inner cylindrical surface and an outer cylindrical surface elongated about a central axis, an inertial mass within the chamber and having an inner cylindrical surface and an outer cylindrical surface elongated about an axis of rotation, the inertial mass and the chamber configured such that the inertial mass is rotatable in the chamber relative to the housing, a first annular centering element and a second annular centering element between the opposed inner cylindrical surfaces of the chamber and the inertial mass or the opposed outer cylindrical surfaces of the chamber and the inertial mass, the annular centering elements configured and arranged to bias the axis of rotation of the inertial mass towards alignment with the central axis of the chamber, a clearance gap between the housing and the inertial mass, the clearance gap having a first portion and a second portion separated by at least one of the centering elements, a bypass channel extending through the inertial mass or at least one of the centering elements from the first portion of the clearance gap to the second portion of the clearance gap, and a viscous fluid within the clearance gap.

The first centering element may be between the opposed inner cylindrical surfaces of the chamber and the inertial mass and the second centering element may be between the opposed outer cylindrical surfaces of the chamber and the inertial mass. The inner cylindrical surface of the inertial mass may comprise a groove and the first centering element may comprise an O-ring seated in the groove. The inner cylindrical surface of the inertial mass may comprise a second groove and the second centering element may comprise a second O-ring seated in the second groove. The outer cylindrical surface of the inertial mass may comprise a groove and the first centering element may comprise an O-ring seated in the groove. The outer cylindrical surface of said inertial mass may comprise a second groove and the second centering element may comprise a second O-ring seated in the second groove. The inner cylindrical surface of the chamber may comprise a groove and the first centering element may comprise an O-ring seated in the groove. The inner cylindrical surface of the chamber may comprise a second groove and the second centering element may comprise a second O-ring seated in the second groove. The outer cylindrical surface of the chamber may comprise a groove and the first centering element may comprise an O-ring seated in the groove. The outer cylindrical surface of the chamber may comprise a second groove and the second centering element may comprise a second O-ring seated in the second groove. The chamber or the inertial mass may comprise a recess configured to provide a reservoir for the fluid and the channel may communicate with the reservoir. The channel may extend through both the inertial mass and at least one of the centering elements.

Accordingly, the general object of the invention is to provide a viscous damper having efficient damping at low operating speeds.

Another object is to provide a viscous damper with efficient fluid dispersion.

These and other objects and advantages will become apparent from the foregoing and ongoing written specification, the drawings, and the claims.

### BRIEF DESCRIPTION OF THE DRAWINGS

FIG. 1 is a perspective view of a preferred embodiment of the inventive viscous torsional vibration damper.

FIG. 2 is a side elevation of the embodiment shown in FIG. 1.

FIG. 3 is a vertical sectional view of damper shown in FIG. 2, taken generally on line A-A of FIG. 2.

FIG. 4 is an enlarged view of the cross-sectional view shown in FIG. 3, taken within the indicated circle B of FIG. 3.

FIG. 5 is a vertical sectional view of a prior art damper.

### DESCRIPTION OF PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

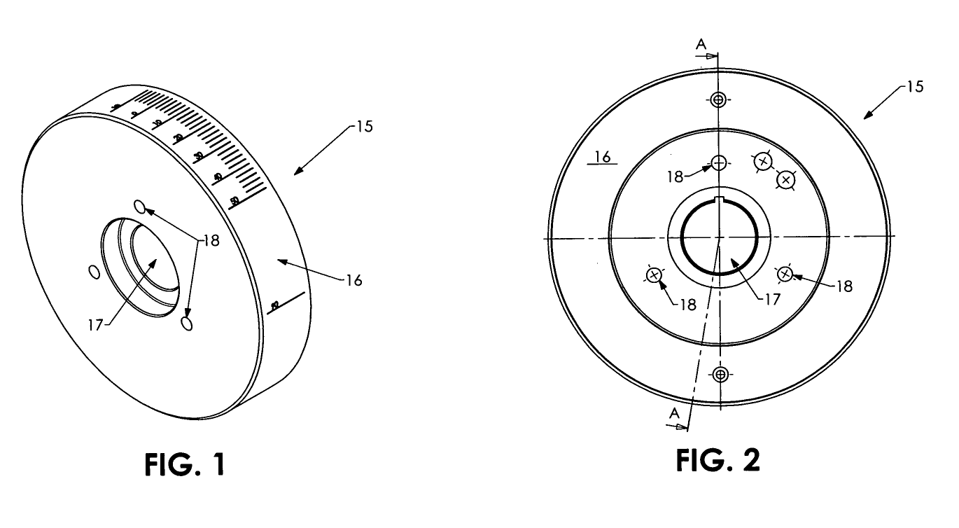

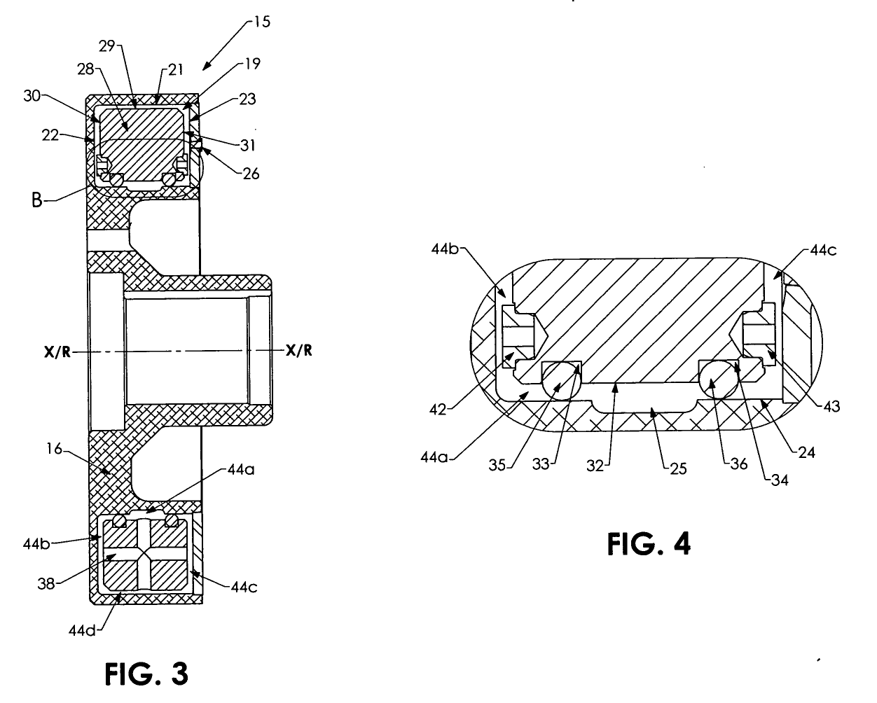

Referring now to the drawings, and more particularly to FIG. 1 thereof, this invention provides a new and improved viscous torsional vibration damper, of which the presently preferred embodiment is generally indicated at 15. As shown in FIGS. 1-3, damper 15 generally includes a housing 16 having a center aperture 17 and a plurality of bolt holes 18 for attaching damper 15 to a rotating shaft. Formed within housing 16 is an annular chamber 19. As shown in FIG. 3, annular chamber 19 is oriented about a central axis x-x and is generally defined by an outside cylindrical surface 21, an annular left side surface 22, an annular right side surface 23, and an inner cylindrical surface 24.

An internal flywheel 28 is contained within chamber 19 of housing 16. Flywheel 28 is adapted to rotate within chamber 19 relative to housing 16 and is oriented about an axis of rotation r-r and has an outer cylindrical surface 29, an annular left side surface 30, an annular right side surface 31, and an inner cylindrical surface 32. Flywheel 28 is proportioned so as to provide small gaps, spaces or clearances 44a-d between surfaces 21, 22, 23 and 24 of chamber 19 and opposed surfaces 29, 30, 31 and 32 of flywheel 28, respectively. Clearances 44a-d between such surfaces contain a viscous fluid or medium, such as silicon. Inner cylindrical surface 24 includes a recessed area 25 for holding a limited supply of such viscous fluid and thereby acts as a fluid reservoir. A tapped fill port 26 is provided through housing 16 in order to allow for chamber 19 to be filled with the viscous fluid.

Flywheel 28 is generally free floating within chamber 19 within the relatively close limits permitted by O-rings 35, 36 and bearings 42, 43 described below and the narrow side and outer peripheral clearances 44a-d containing viscous fluid. As clearances 44a-d are generally filled with a viscous fluid having a high shear and compression resistance, at high speeds the viscous fluid becomes more and more resistant to relevant movement of flywheel 28 and housing 16. With the various surfaces of flywheel 28 closely spaced with respect to the opposing surfaces of chamber 19, maximum shear resistance efficiency is obtained in the operation of damper 15. Damper 15 thereby operates to damp vibration in the shaft or other rotational mass or member to which damper 15 is operatively connected.

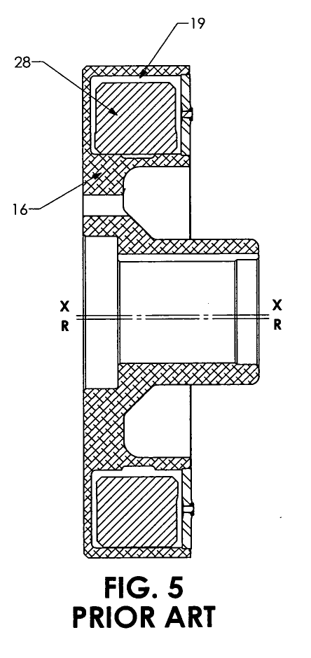

As shown on FIGS. 3 and 4, in the preferred embodiment annular rectangular grooves 33 and 34 are cut into flywheel 28 and extend into inner cylindrical surface 32 of flywheel 28. Centering elements 35 and 36 are seated in grooves 33 and 34. In the preferred embodiment, centering elements 35 and 36 are closely-toleranced elastomeric O-rings. Grooves 33 and 34 have a depth, relative to centering elements 35 and 36, such that centering elements 35 and 36 will bias the axis of rotation r-r of flywheel 28 towards alignment with the center axis x-x of chamber 19 and housing 16 when flywheel 28 is not rotating at high speeds or is idle. By maintaining radial concentricity and alignment between flywheel 28 and housing 16, damper 15 has improved operating parameters, as flywheel 28 does not settle in housing 16 when not operating at optimal speeds. As shown in FIG. 5, this settling would otherwise occur as by gravitation flywheel 28 takes up the clearance gap 44 between opposed surfaces of flywheel 28 and chamber 19 and the normal tolerance that exists concentrically between flywheel 28 and housing 16. This settling can increase the imbalance in the damper that exists due to normal manufacturing tolerances and results in less damping during start up and until the damper reaches full operating speed. Without this centering assembly, until damper 15 reaches operating speed and centers do to the properties of the viscous medium, the rotating shaft or mass being damped would be exposed to increased levels of harmful torsional vibrations. A pair of button bearings 42 and 43 are provided to maintain the axial alignment of flywheel 28 in chamber 19.

It is contemplated that the centering elements may be located between opposed surfaces of flywheel 28 and chamber 19 at other locations or in other relative orientations. For example, rather than in the inner cylindrical surface 32 of flywheel 28, the grooves and corresponding O-rings could be provided in the inner cylindrical surface 24 of housing 16, in the outer cylindrical surface 29 of flywheel 28, in the outer cylindrical surface 21 of housing 16, or in a combination of the forgoing. While centering elements 35 and 36 are O-rings in the preferred embodiment, it is contemplated that they can be made of other elastomeric or springlike materials and may have other cross-sections. Similarly, grooves 34 and 35 may have other non-rectangular cross-sections. As a further alternative, other compressible mechanical spring-like elements may be used to create a radial centering bias to flywheel 28, with the preload of the compressible elements radially centering or aligning flywheel 28 in housing 16.

If self-centering rings 35 and 36 are made of a compressible material, the amount of hardness, compress and torsional elasticity designed into the centering rings allows for further adjustment of the damping rate of damper assembly 15. By controlling the compression and the amount of torsional elasticity developed by centering rings 35 and 36 between flywheel 28 and housing 16, it is possible to develop a controlled amount of damping. This is in addition to the viscous damping due to shear of the viscous medium in gap 44 between flywheel 28 and housing 16. Additional damping is adjustable by manipulation of the centering rings, which allows damper 15 to be tuned to better damp the torsional vibrations occurring at the specific operational ranges being damped. Also, additional damping by manipulation of the properties of the self-centering rings may allow the damping rate of the damper to be increased to a level that is not otherwise achievable through other means, such as adjustment of the clearance gaps 44 between flywheel 28 and housing 16 or adjustment of the viscosity of the viscous medium in clearance gaps 44.

As shown in FIG. 3, in the preferred embodiment flywheel 28 includes fluid bypass passages or channels 38. Fluid passages 38 connect reservoir 25 and clearance gap 44 to clearance gaps 44b-d between surfaces 30, 31 and 32 of flywheel 28 and opposed surfaces 22, 23 and 24 of chamber 19. Centering O-rings 34 and 35 will act as a barrier to the free flow of viscous fluid from reservoir 25 and gap 44a around the peripheral of flywheel 28 to clearances 44b and 44d and clearance 44d. Passages 38 allow for the viscous fluid to bypass these barriers and to move more freely during operation of damper 15. Fluid channels 38 thereby allow for the viscous medium to be more evenly distributed and help prevent undesirable hydraulic imbalances that may arise during operation, thereby minimizing high or low relative pressure zones or negative pressure zones that might occur around flywheel 28 and impede optimal operation of damper 15. Alternatively, channels or gaps may be provided through centering rings 35 and 36 to allow for the viscous fluid to bypass such barriers and to move more freely during operation of damper 15.

The present invention contemplates that many changes and modifications may be made. Therefore, while the presently-preferred forms of the damper has been shown and described, and a number of alternatives discussed, persons skilled in this art will readily appreciate that various additional changes and modifications may be made without departing from the spirit of the invention, as defined and differentiated by the following claims.

What is claimed is:

1. A viscous torsional vibration damper comprising:
a housing adapted to be connected to a rotary member to be damped;
said housing comprising an annular chamber having an inner cylindrical surface and an outer cylindrical surface oriented about a central axis;
an inertial mass within said chamber and having an inner cylindrical surface and an outer cylindrical surface oriented about an axis of rotation;
said inertial mass and said chamber configured such that said inertial mass is rotatable in said chamber relative to said housing;
a clearance gap between said housing and said inertial mass;
a viscous fluid disposed in said clearance gap;
at least one centering element between said opposed inner cylindrical surfaces of said chamber and said inertial mass or said opposed outer cylindrical surfaces of said chamber and said inertial mass; and
said centering element configured and arranged to bias said axis of rotation of said inertial mass towards alignment with said central axis of said chamber.

2. The damper set forth in claim 1, and further comprising a second centering element between said opposed inner cylindrical surfaces of said chamber and said inertial mass or said opposed outer cylindrical surfaces of said chamber and said inertial mass, said second centering element configured and arranged with said centering element to bias said axis of rotation of said inertial mass towards alignment with said central axis of said chamber.

3. The damper set forth in claim 2, wherein said centering element is between said opposed inner cylindrical surfaces of said chamber and said inertial mass and said second centering element is between said opposed outer cylindrical surfaces of said chamber and said inertial mass.

4. The damper set forth in claim 1, wherein said centering element is an O-ring.

5. The damper set forth in claim 4, wherein said inner cylindrical surface of said inertial mass comprises a groove and said O-ring is seated in said groove and extends in an uncompressed state at least beyond the edge of said groove and said inner cylindrical surface of said inertial mass.

6. The damper set forth in claim 2, wherein said inner cylindrical surface of said inertial mass comprises a first groove and a second groove, said centering element comprises an O-ring seated in said first groove, and said second centering element comprises an O-ring seated in said second groove.

7. The damper set forth in claim 2, wherein said outer cylindrical surface of said inertial mass comprises a first groove and a second groove, said centering element comprises an O-ring seated in said first groove, and said second centering element comprises an O-ring seated in said second groove.

8. The damper set forth in claim 1, wherein said inner cylindrical surface of said chamber comprises a first groove and a second groove, said centering element comprises an O-ring seated in said first groove, and said second centering element comprises an O-ring seated in said second groove.

9. The damper set forth in claim 1, wherein said outer cylindrical surface of said chamber comprises a first groove and a second groove, said centering element comprises an O-ring seated in said first groove, and said second centering element comprises an O-ring seated in said second groove.

10. The damper set forth in claim 1, and further comprising a bypass channel extending through said inertial mass.

11. The damper set forth in claim 10, wherein at least one of said chamber and said inertial mass comprises a recess configured to provide a reservoir for said fluid and wherein said channel communicates with said reservoir.

12. A viscous torsional vibration damper comprising:
a housing adapted to be connected to a rotary member to be damped;
said housing comprising an annular chamber having an inner cylindrical surface and an outer cylindrical surface elongated about a central axis;
an inertial mass within said chamber and having an inner cylindrical surface and an outer cylindrical surface elongated about an axis of rotation;
said inertial mass and said chamber configured such that said inertial mass is rotatable in said chamber relative to said housing;
a first annular centering element and a second annular centering element between said opposed inner cylindrical surfaces of said chamber and said inertial mass or said opposed outer cylindrical surfaces of said chamber and said inertial mass;
said annular centering elements configured and arranged to bias said axis of rotation of said inertial mass towards alignment with said central axis of said chamber;
a clearance gap between said housing and said inertial mass;
said clearance gap having a first portion and a second portion separated by at least one of said centering elements;
a bypass channel extending through said inertial mass or at least one of said centering elements from said first portion of said clearance gap to said second portion of said clearance gap; and
a viscous fluid within said clearance gap.

13. The damper set forth in claim 12, wherein said first centering element is between said opposed inner cylindrical surfaces of said chamber and said inertial mass and said second centering element is between said opposed outer cylindrical surfaces of said chamber and said inertial mass.

14. The damper set forth in claim 12, wherein said inner cylindrical surface of said inertial mass comprises a groove and said first centering element comprises an O-ring seated in said groove.

15. The damper set forth in claim 14, wherein said inner cylindrical surface of said inertial mass comprises a second groove and said second centering element comprises a second O-ring seated in said second groove.

16. The damper set forth in claim 12, wherein said outer cylindrical surface of said inertial mass comprises a groove and said first centering element comprises an O-ring seated in said groove.

17. The damper set forth in claim 116, wherein said outer cylindrical surface of said inertial mass comprises a second groove and said second centering element comprises a second O-ring seated in said second groove.

18. The damper set forth in claim 12, wherein said inner cylindrical surface of said chamber comprises a groove and said first centering element comprises an O-ring seated in said groove.

19. The damper set forth in claim 18, wherein said inner cylindrical surface of said chamber comprises a second groove and said second centering element comprises a second O-ring seated in said second groove.

20. The damper set forth in claim 12, wherein said outer cylindrical surface of said chamber comprises a groove and said first centering element comprises an O-ring seated in said groove.

21. The damper set forth in claim 20, wherein said outer cylindrical surface of said chamber comprises a second groove and said second centering element comprises a second O-ring seated in said second groove.

22. The damper set forth in claim 12, wherein said chamber or said inertial mass comprises a recess configured to provide a reservoir for said fluid and said channel communicates with said reservoir.

23. The damper set forth in claim 12, wherein said channel extends through both said inertial mass and at least one of said centering elements.
